(19) United States
(12) Patent Application Publication
(10) Pub. No.: US 2006/0085824 A1
(43) Pub. Date: Apr. 20, 2006

(54) Method and appartus for management of video on demand client device

(76) Inventors: Timo Bruck, Mountain View, CA (US); Thomas R. Hammer, San Mateo, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/966,403

(22) Filed: Oct. 14, 2004

(51) Int. Cl. H04N 7/173; H04N 5/445; H04N 5/44; G06F 13/00; G06F 3/00

(52) U.S. Cl. 725/86; 725/116; 725/115; 725/105; 725/37; 348/734

(57) ABSTRACT

Method and apparatus for enhancing user experience in a VOD system by providing a facility to remotely control a client device is disclosed. In one exemplary embodiment, a method to synchronize in-band and out-of-band settings of the client device is provided. In another embodiment, a method to perform synchronization of content catalogue on the client device with network-side counterpart with minimal burden on network bandwidth is provided.

### BACKGROUND OF THE INVENTION

1. Field of the Invention

The invention relates generally to the field of video on demand (VOD). In one exemplary aspect, the invention relates to the management of content stored on a VOD client device in multiple ways - direct interaction with the client device and/or interaction with a replica of dataset of the client device parameters stored on a network server.

2. Description of Related Technology

### Conventional VOD Architecture

With the recent advances in computing, signal processing and telecommunications technologies, the ability to download and watch audio/video content over a network connection is opening up new opportunities to deploy VOD services.

VOD generally refers to a personalized viewing service offered by a content provider or a network operator over a network to a content viewer. The viewer is able to start a VOD session by electronically browsing through a catalog of available content, selecting a program for viewing and receiving the selected content for viewing over the network via a client device.

An example high level block diagram of a conventional VOD network is shown in FIG. 1. A client device 114 is connected to a near-end server called an edge server 110 through a network connection 112. The network connection 112 is typically called an “access network” and can be, for example, a coaxial cable connection, a DOCSIS connection, a satellite downstream and telephone upstream connection, and so on. The entire VOD content in general may not be available at the edge server 112, but could located on one or more content servers 100 at a different location. The connection between content server 100 and edge server 110 is made via an intermediate network 104 which could for example be the Internet, a wide area network (WAN), a private network or a Storage Area Network (SAN) and so on. When the content is passed from content server 100 to a client device 114 during a VOD session, the appropriate resources have to be allocated for transfer of the content over the intermediate networks, links (102, 108, 112) and servers.

### VOD Server

For the purpose of this disclosure, the term “VOD server” refers to one or more network-side servers and components that work together to achieve the desired user experience in a VOD service. This includes, for example, content servers, billing system servers, user home page servers, web servers and so on. The conventional VOD servers provide limited capability for a user to interact with the content and billing features of the VOD service. A user can, for example, browse through the selection of content available on one of the several interconnected content servers and select a program for viewing. The servers also allow for bill payment/account management by the user. A user could do this either by invoking an appropriate application from his client device, or by using a personal computer (PC)/workstation to perform these tasks over a connection such as a secure socket layer (SSL) connection over the Internet.

Despite the advances in technologies related to browsing available VOD programs, conventional solutions do not include the ability to remotely browse through content already downloaded and stored on the VOD client device. With the emergence of VOD client devices with local storage capability, such ability to browse remotely through both local content and content available on the network in a seamless manner is of commercial importance.

### VOD Client Device

In a conventional VOD service deployment, the service provider provides the user with a client device. Examples of such VOD client devices include a digital set-top box in cable networks, a satellite receiver for direct-to-home (DTH) satellite television networks, and an Internet Protocol (IP) set-top box in Digital Subscriber Line (DSL) networks. These client devices typically contain security features that are used by the service providers for authentication of program downloads and typically come pre-installed with a VOD client application for interacting with VOD servers. The communication between the client device and the VOD servers, initiated by the client device, is limited to interactive activities such as browsing available content, purchasing content for viewing or paying bills by the user.

Due to the rather limited functionality of a conventional VOD client device, there is no need to perform periodic communication with VOD servers, as will be needed for a client device with local storage. A key feature of such a VOD client device is an application running on the client that fetches content from the network. Such an apparatus is disclosed in co-pending U.S. patent application Ser. No. ______ (Attorney Docket No. 7177P001) entitled “Method and apparatus for downloading content” filed Aug. 27, 2004, assigned to the assignee of the present invention and incorporated herein by reference. Due to such dynamic usage of the client's local storage, there is a need for a method to make the state of the client device available to the network-side servers.

### User Control in a VOD System

In a conventional VOD system deployment, various means are available to a user to control one or more aspects of the VOD service. The control means range from front or back panel switches (e.g., power switch, up/down/menu/volume control, etc.) to interactive applications using wireless remote control to PC-based interactive sessions for account management/bill payment over the Internet.

User interaction with conventional VOD services and VOD client devices is substantially remote control based, using a television as the display for such interaction. FIG. 2 shows user control options available in conventional VOD client devices. The client device (208) is connected to the network cloud (204) that contains VOD servers via an access network connection 206. The client device is also connected to a remote control 212 over a link 214. The Graphical User Interface (GUI) used for the user interaction is made available to a user via a connection (210) to a display device. The user interaction with the VOD system could be limited to an application running on the client, or the user could use the remote control and client device over an in-band connection (216) to a server somewhere in the network 204. Similarly, there is a second connection; the out-of-band connection 202 that connects some other user controlled device (200), such as a PC, to the VOD servers via a network (typically the Internet) connection 202. Such “out-of-band” interaction is usually limited to bill payments and account management.

However, use of the Internet does not have to be limited to an out-of-band connection to a billing system, as noted above. With the increasing penetration of high-bandwidth Internet access and advances in audio and video compression and streaming media technologies, entertainment and educational content is becoming increasingly available over the Internet. The conventional approach to VOD does not provide the ability for a user to leverage the ubiquitous connectivity offered by the Internet to perform content search, discovery, and selection for viewing using a VOD client device.

Recently, there has been an emergence of VOD client devices with caching capability (such as those combined with a personal video recorder). This has magnified the need for versatile control of VOD client devices. Further, it would be advantageous for such a method of control to provide for seamless and unified content management on the client device (including download, deletion and preservation of content), content discovery over the Internet, and account management. Such a method must be provided with an eye towards the constraint that it does not put unnecessary burden on the access bandwidth available to the VOD client.

Based on the foregoing, it will be evident that while the prior art has in general recognized the utility of providing network access of VOD servers to users, it lacks a method to extend access to locally stored VOD content, and doing so without burdening the bandwidth resource of an access network connection to the client device.

### SUMMARY OF THE INVENTION

The present invention addresses the foregoing needs by providing, in various embodiments, a method and apparatus for providing access to local content on a VOD client from a computer system on a network, communicatively connected to the VOD client.

In a first aspect of the invention, a remote control for a set-top appliance includes a user interface accessible via the Internet. The user interface provides one or more views of a database configured to periodically synchronize with a (database associated with a) content management application hosted at the set-top appliance. The user interface further includes a content availability guide configured to present multimedia content available for download by the set-top appliance.

In a second aspect of the invention, a method to control operations of a set-top appliance having a local computer-readable storage medium and a local user interface (e.g. a wireless remote control) through an out-of-band communication channel that includes an Internet accessible user interface having one or more Web pages configured to provide views of a remote database maintained in substantial synchronization with a local database hosted at the set-top appliance which contains information regarding content stored on the local computer-readable storage medium is disclosed.

In a third aspect of the invention, a content management system for a set-top appliance, comprising an in-band user interface, which includes a wireless remote control operable to display views of a local database hosted at the set-top appliance via a display device communicatively coupled thereto, and an out-of-band user interface including one or more Web pages configured to provide views of a remote database maintained in substantial synchronization with the local database hosted at a server remote from the set-top appliance is disclosed.

### BRIEF DESCRIPTION OF THE DRAWINGS

The above and other features and advantages of the present invention are hereinafter described in the following detailed description of illustrative embodiments to be read in conjunction with the accompanying drawings, wherein like reference numerals are used to identify the same or similar system parts and/or method steps, and in which:

FIG. 1 illustrates a conventional video-on-demand network.

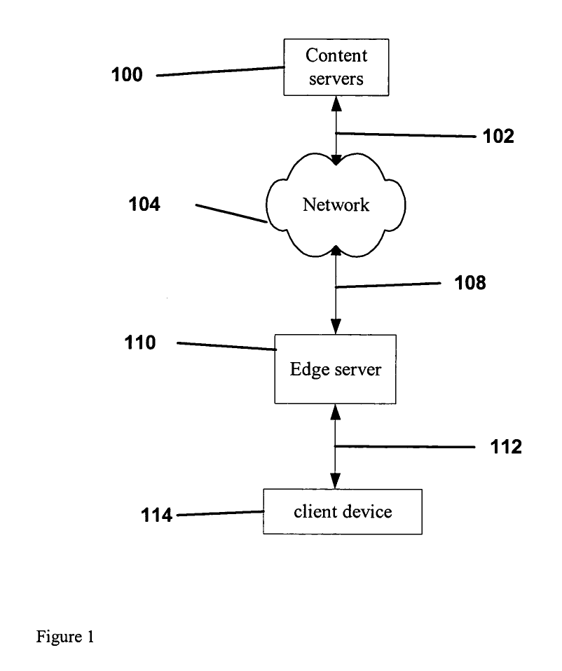

FIG. 2 illustrates a functional block diagram of a VOD client device illustrating two different network connections available for user interaction with VOD servers—an in-band connection and an out-of-band connection.

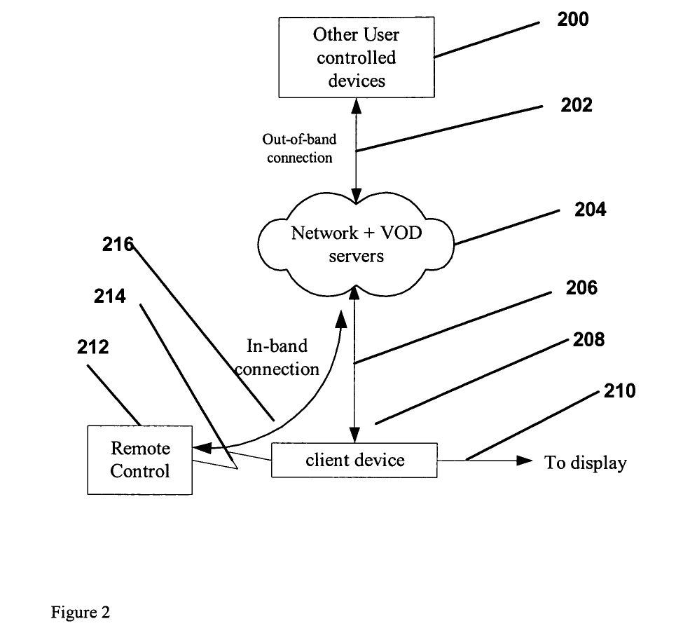

FIG. 3 illustrates a flow graph of the algorithmic steps used to ensure the preservation of content requested via an out-of-band connection is properly executed according to an embodiment of the present invention.

FIG. 4A illustrates example network connections over which the interaction with a VOD client device is possible as per an embodiment of the present invention.

FIG. 4B illustrates three example embodiments showing a communication channel between a computer system and a VOD client device.

FIG. 5 illustrates an example web page layout for out-of-band control of a client device according to an embodiment of the present invention.

FIG. 6 illustrates a signal exchange diagram showing how parameter synchronization is performed according to the present invention.

FIG. 7 shows an example web page showing in the out-of-band interface the content available on local storage of a client device.

### DETAILED DESCRIPTION

Reference is now made to the drawings wherein like numerals refer to like parts throughout. Described herein is a method and apparatus for management of features of a storage-capable VOD client device. The present invention overcomes the limitations of above-described conventional VOD systems, in part by providing a software module to control features of a VOD client device. In one embodiment, a computer program adapted to run on a network accessible server in the form of a customized web page for each user (represented in an embodiment as the MyAkimboTm home page facility provided to users by the assignee of the present invention) is used to control features of individual client devices.

As used herein, the term “VOD” is meant to include on-demand delivery of audio, video, graphical icons, software, computer games, etc.

As used herein, the term “VOD server” is meant to include network-side server resources of a VOD system in the form of a computing platform, including content servers, billing system servers, web interface servers, the network operator's management servers, and so on.

As used herein, the term “operator” is meant to refer to an entity, other than a home or end-user, involved in manufacturing, design, deployment or maintenance of a system embodying the present invention, including but not limited to cable system operators, satellite providers, DSL internet providers, content providers, client device manufacturers, etc. as appropriate.

As used herein, the term “content” refers to audio, video, graphics files (in uncompressed or compressed format), icons, software, text files and scripts, data, binary files and other computer-usable data used to operate a client device and produce desired audio-visual effects on a client device for the viewer.

As used herein, the term “remote control” refers to any control element or interface not strictly physically coupled to the device under control. Typically, though not necessarily, such controls are communicatively coupled through wireless infrared communication links.

As used herein, the terms “computer-implemented method,” “computer program”, “routine,” and “subroutine” are substantially synonymous, with “computer method” being used typically (but not exclusively) to describe collections or groups of the latter two elements. Such programs and routines/subroutines may be rendered in any language including, without limitation, C#, C/C++, Fortran, COBOL, PASCAL, assembly language, markup languages (e.g., HTML, SGML, XML, VOXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

As used herein, the term “database” is meant to refer to a set of information bits, stored in a computer readable form such as registers, volatile or non-volatile memory, magnetic, optical or other storage devices. Such a set contains information of for example, but not limited to, hardware and software settings and states of a device, user preferences, actual content of files or address locations to accessing files and peripheral devices.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. Where illustrated, the user interfaces presented herein should be regarding as examples thereof and not read so as to limit the scope of the present invention. Layouts, images and other elements of such user interfaces are not critical to the present invention. The functionality provided by such interfaces is reflected in the claims following this description and it is that functionality which forms a component of the present invention.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the present invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

### Overview

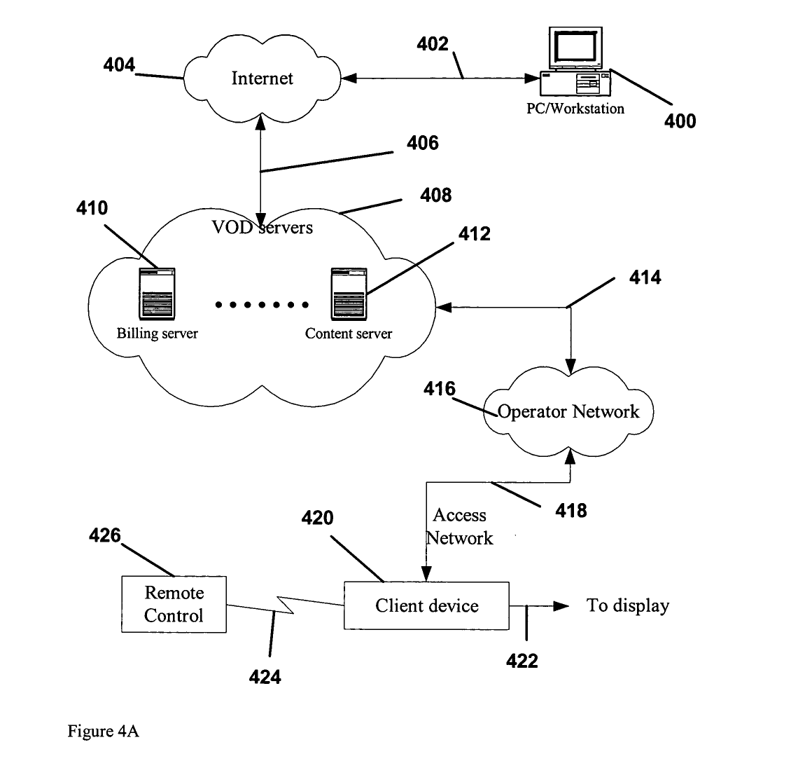

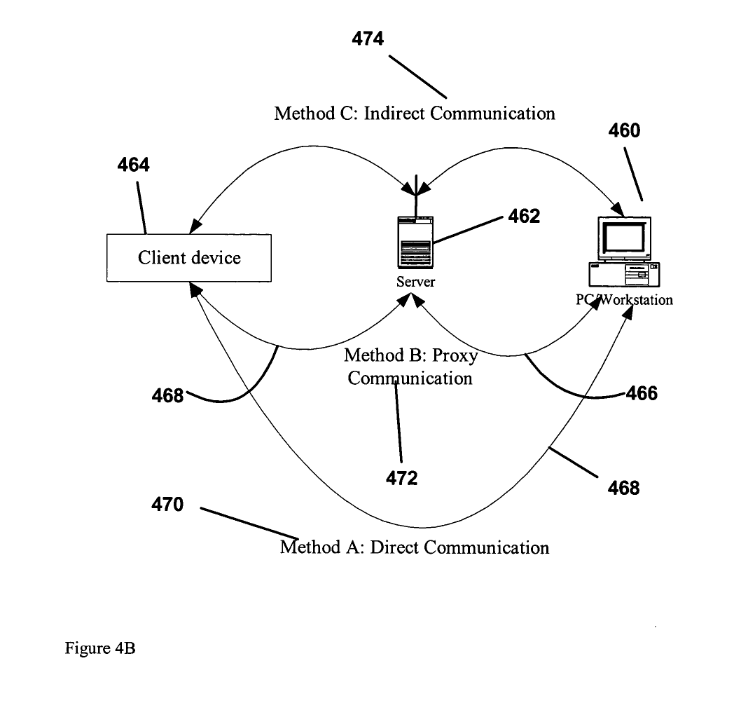

FIG. 4A shows a network diagram that is typical of VOD service deployments that use the Internet and IP protocol to connect servers and client devices. FIG. 4A contains only architectural elements that are directly relevant to the description of current invention and omits several other architectural elements that could exist in a VOD service deployment that are indirectly relevant to the present invention. In the figure, a client device (420) is shown connected to a remote control (426) via a wireless link 424. The client device typically has an output 422 to a display device such as television or computer monitor. The client device is connected via a connection 418 labeled “Access Network” to an operator-managed network labeled “Operator Network” (416). For example, in the case of coaxial cable networks, the access network uses MPEG transport in the downlink (from the network to the client device) and operator-specific proprietary protocol in the uplink (from the client device to the network) and the operator network consists of various servers at a digital cable headend. Similarly, in case of a DOCSIS deployment, the access network part consists of DOCSIS downstream and upstream and the operator network consists of Cable Modem Termination System (CMTS) and other headend servers.

The operator network 416 is in turn connected via a network connection 414 to a collection of various servers used in fulfilling VOD service. This collection of servers is represented by a cloud 408 labeled “VOD servers”. This collection of servers includes, for example, one or more billing servers (410), one or more content servers (412) and so on. A user with a PC (400) is given limited access for interaction with these servers over connection 402 via the public Internet 404, in which a subset of servers from the server cloud 408 is made accessible via link 406. One of the objectives of the current invention is to extend the interaction between a user connecting to the VOD service using his PC over the Internet beyond the limited billing and account management functions to provide him the access and ability to manage content and features residing on his client device (420). This access is provided indirectly through a server in the VOD server cloud, which maintains a replica of the user's client device settings. The user then interacts with this replica over the Internet.

### Interaction with the VOD Client Device

Since the VOD client device is communicatively connected to the network to which other servers and computer systems described above are also communicatively connected, a communication channel between the client device and the computer system may be established over the network. Several embodiments are possible for implementing such a communication channel. FIG. 4B shows three such possible implementations. Method A, labeled 470, uses a direct communication path 468 between a computer system 460 on the Internet and a VOD client device 464. One of several possible conventional techniques can be used to enable such communication and allow the computer system the ability to view program titles on the client device and control various functional aspects of the client device. Such techniques include, without limitation, the usage of a web client/server architecture, Remote Procedure Calls (RPCs), Java programming techniques, telnet protocols, Wireless Application Protocol (WAP), custom applications and protocols, and so on. It will be appreciated by practitioners of the art that ubiquity of many such techniques cannot be guaranteed due to possible limitations on the type of network traffic allowed by a number of intervening network elements such as firewalls, proxy servers, limited upstream bandwidth, time varying IP addresses for the client device (e.g., dynamic Host Control protocol or DHCP assigned IP addresses), and so on.

A second possible technique that overcomes some of the limitations of the above method is shown as “Method B—proxy communication” (472). In this method, a server 462 is used as an intermediary. Such a server could be present in the part of the network where there are fewer restrictions on the types of permitted communication (for example at the VOD service provider's back office) and can be configured to provide proxy services on behalf of the client device. For example, in some cases, the computer system 460 may not be able to directly communicate with the client devices (e.g., it may be unaware of the client devices' IP addresses). In such a case, the server could host, in proxy, an interactive session with the computer system 460 (as shown by signal 466) while maintaining communication with the client device (shown as signal 468). Depending on the nature of the IP network where the client device and the VOD server are deployed, there may or may not be an ISP's firewall between the two, potentially creating a communication barrier.

FIG. 4B shows a third method labeled 474 called “Method C—Indirect communication.” This method is intended to overcome the communications problems with the earlier two embodiments described in the previous paragraphs, provide a simpler implementation of the client device and be able to offer a broader database to browse from by positioning it on the intermediate server-based. This method is described more fully below.

### In-Band Interface

As used herein, the terms “in-band interface” and “in-band connection” are substantially synonymous with “in-band interface” being used typically (but not exclusively) to describe connection used for interaction with a VOD client device that interacts with a hardware/software component running on the client. The interactive application could either be hosted on the client device, or hosted on a VOD server, with the client device acting as “a pipe” to allow interaction over its network connection between the user and a network-side VOD server. Examples of interactivity using an in-band interface include: volume controlling playback using front panel keys, VOD server content browsing applications launched using an infrared wireless remote control, setting a parental control password using a wireless remote control, and so on.

### Out-of-Band Interface

As used herein, the term “out-of-band interface” is used to describe a network connection to a VOD system available to the user to perform control and interaction with the VOD service and a client device. Payment of a bill by secure login over the Internet using a web browser is an example of interactivity over the out-of-band interface. In general, interactivity over the out-of-band interface may not directly result in any traffic, real time or otherwise, to a client device or reaction from the client device.

### Partitioning Feature Set of a VOD Client Device

A VOD client device in general has one or more features that are user-controllable. These features are typically stored in the form of a functionality database. According to the present invention, each of these features is conceptually grouped in one of three possible categories. The first category consists of all features that are controllable over the in-band interface only. The second category consists of features that are controllable both over the in-band interface and the out-of-band interface. The third category consists of features that are controllable over the out-of-band interface only. For example, the ability to change output audio volume is typically a “category one” feature as it available over the in-band interface, but not over the out-of-band interface. Another example, the ability to browse available content stored on a local hard drive, may be available over both in-band and out-of-band interfaces, making it a “category two” feature. The ability to browse, edit and rearrange a priority list of content titles to download could be another “category two” feature. Yet another example, the ability to read user-contributed reviews of programs may only be available over the out-of-band interface, making it a “category three” feature.

The partitioning of features is for conceptual purpose only and implementations may or may not treat the database entries of these three categories in a special way. In one embodiment, the attributes of the three categories are stored in a database with a metadata tag for each entry that identifies permissions regarding which interfaces (in-band or out-of-band or both) can view/modify the corresponding attribute. In another embodiment, the access privileges to the database entries of these features could be restricted at software build-time. Various other embodiments are possible.

### Synchronization of States

When a new client device is introduced in the VOD network, values of many entries in the functionality database are known (the so-called “factory default setting”). Settings and values of some parameters are typically selected or modified during initial installation of the device. Such initialization may be performed without any communication between the client device and the VOD service, but more typically some form of such communication is required. In one embodiment of the present invention, during initialization a cross-check is performed to ensure that all the “category two” database entries (i.e., entries that can be viewed/modified over both in-band and out-of-band interfaces) on the client device match with a corresponding copy on the VOD service server. This creates a clean “starting point” for the state of the client device as reflected in a database replica by the VOD servers.

During operation, the functionality database can be either viewed or modified over either an in-band or an out-of-band interface. In the preferred embodiment of this invention, when the user is viewing or modifying these parameters over the in-band interface (for example using a wireless remote control associated with the client device), the interaction is performed on the parameters saved on the client device. Similarly, when the user is viewing/modifying these parameters over the out-of-band interface, he is in fact viewing/modifying a replica of the client device's functionality database that is stored on the VOD server. The present invention implements a plurality of synchronization methods to ensure both the client-side and the server-side copies of the parameters remain identical. In the preferred embodiment of the invention, the synchronization step is initiated by the client device based on pre-determined criteria such as passage of time, number of parameters changes made locally, criticality of parameter changes, user's explicit command to synchronize, availability of network bandwidth, and so on. A similar set of rules is used to perform either “full synchronization”, meaning all parameters are read back to and from the server regardless of whether they were changed or not, or “partial synchronization”, meaning the parameters that were changed are read back and synchronized.

### Race Conditions and Conflict Resolution

In general, it is possible that one or more users of the same client device may be running simultaneous or near-simultaneous sessions on the in-band and out-of-band connections. This could potentially lead to a race condition such that between two successive synchronizations of the database, the value of the same entry gets changed on both the client device and the VOD server without the changes being communicated to each other. The present invention provides a method to ensure that such a situation does not lead to ambiguous parameter settings. The method uses a set of rules to resolve ambiguity. These rules that can be changed by the user or network operator. Each command to change parameters, whether via the in-band or the out-of-band interface, is logged with a time code corresponding to when the command was received. This time code is one of the means used to resolve conflicts. In one exemplary embodiment, the earliest issued command is implemented while later commands are dropped or ignored, and a corresponding message is optionally issued to the user. In another exemplary embodiment, only the last issued command is implemented and earlier ones are ignored. In general, many combinations of such rules for precedence of commands are possible based on command issue time, type and criticality of parameter changes. In another exemplary embodiment, the ability to immediately trigger synchronization is provided. To ensure that any conflicts with settings are resolved in the order of priority, synchronization files are organized in order of priority.

### Preservation of Content

Once a program downloaded to a client device has been viewed, it may be marked for automatic deletion by a content management or storage space management process running on the client device. Similar rules might be implemented to remove content older than a certain window of time, whether or not it has been watched or based on conditions of a digitally managed license for that program. According to the present invention, a user is given the ability to provide input to this automated storage deletion process by marking content on the hard drive for non-removal from the process. The user could perform such selection over the in-band or the out-of-band interface.

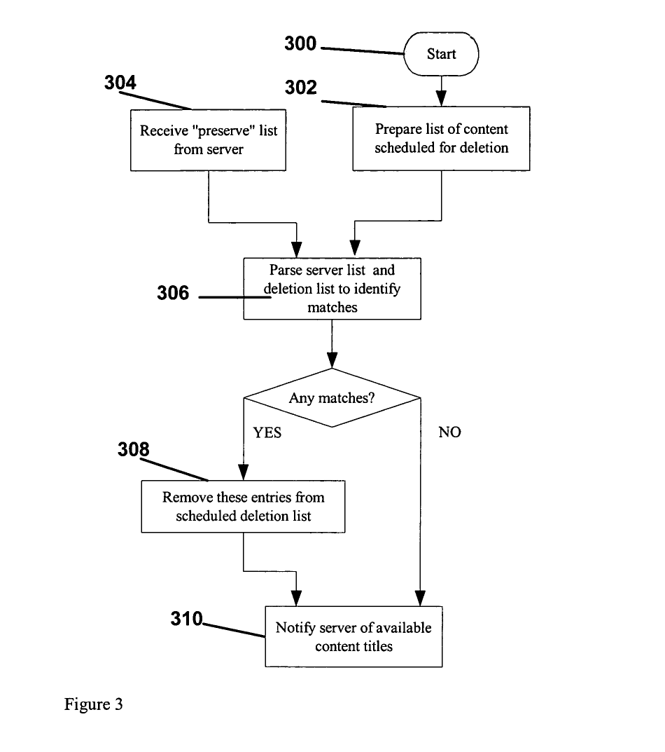

An embodiment of the present invention provides a simple method to check a menu box called “Preserve” next to each program title that the user can select while browsing titles available on the local storage. The algorithm used to ensure that content is not automatically deleted while still being present on the list of available programs prior to a parameter synchronization step is shown in FIG. 3. At the beginning of the process (300) the storage space management process prepares a list of all content scheduled for deletion soon after an upcoming synchronization step (302). During the synchronization step, when the parameter list from the server is received (304), it is parsed to see if a “Preserve” request was made for any of the content scheduled for deletion (306). If so, the content scheduled for deletion is removed from the scheduled deletion list (308). The remaining list of scheduled deletions is notified to the server as having been deleted (310); thereby removing these titles from the list of available programs.

### Network Bandwidth Requirements

From the discussion of synchronization of databases above, it is evident that such synchronization will periodically use network bandwidth and computational resources on both the server and the client device performing the synchronization. It is therefore important to regulate how often this synchronization is performed.

According to the present invention, a software agent is provided on the client device. This agent controls the frequency of how often synchronization is performed. All messages intended for a client device are buffered on the server till that client initiates communication with the server. One of the reasons this method is advantageous is because each client device is in a better position to evaluate availability of bandwidth on its access network connection and priority of any other network traffic to/from it. The network operator could change the behavior of client devices by adjusting the nominal period of synchronization. In one embodiment, the client device can add a random delay to this nominal period. This helps to statistically stagger the synchronization requests from multiple client devices to the VOD server. Another reason this method is advantageous is because communication started by client devices overcomes potential firewall penetration problems in some implementations.

### “Download Next” Request Over in-Band Control

During an Internet browsing session, a user might come across and request content that he wants to be able to download and view right away. This request is cued up at the top of the priority list of download such that when the client device queries the server. Any lower priority downloads including those currently underway on the client device are pre-empted.

### Client Failure to Communicate

Due to the above-described synchronization mechanism, the connectivity between VOD servers and client devices provides not only for content download but also to ensure an effective user experience. The present invention is designed to take into account periodic network interruptions. The user is made aware of failures to synchronize and communicate with the network in several ways, including front panel LEDs and error messages on GUIs. The database synchronization is made robust by providing a lifetime for each message queued up for exchange. This allows the synchronization process to make decision regarding for how long unfinished communications messages should be buffered. In one aspect of the invention, the method is designed to work even during network outages. In one embodiment of the present invention, the client device can function even when completely disconnected from the network.

### Additional Services Enabled

The availability of information to a network-side server regarding each user's VOD client device and service options in the form of a synchronized database lends itself to several possible additional services to the users. In an exemplary embodiment, a user could interact not only with his own box, but, with the appropriate permissions, he could see and control content on any number of client boxes from his in-band or out-of-band connections. Thus, this could enable, for example, shared libraries with sub-group views, the ability to ‘push’ content to multiple boxes, etc.

By using the network-side replica database, a VOD service provider can offer redundancy or “back-up” service for a VOD subscriber in case content is lost on the box, or provide viewing history in case of billing disputes, etc.

### Description of Exemplary Embodiments

Exemplary embodiments of the method and apparatus of the present invention are now described in detail.

### Prioritized List of Parameters

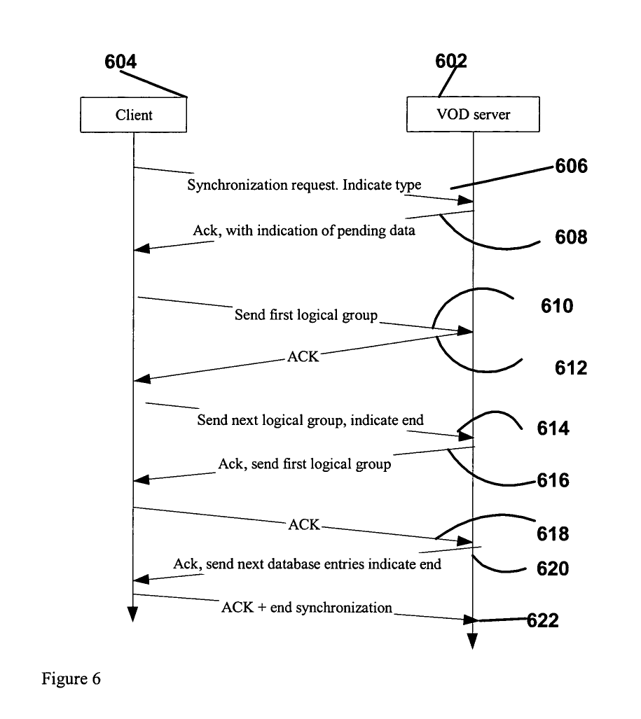

FIG. 6 shows an exemplary message exchange between a client device and VOD server during functionality database synchronization. The client device (602) initiates a synchronization request 606 to the VOD server 604. In this request, the client device indicates the type of synchronization requested (e.g., full synchronization, partial synchronization, a poll of the server, or combination thereof, to see if the server needs to send any changed/updated/new database entries to the client device). In one embodiment, this message could include all the parameters the client wants to send to the server. The VOD server sends an optional acknowledgement of receipt of this message (608) and indicates if it needs to convey changes to database back to the client device. After this initial handshake, the parameter list is sent from the client device to the VOD server in groups of prioritized messages (610) and the corresponding optional acknowledgements are sent from the VOD server (612). The last message from the client device to the VOD server (614) indicates that it has finished sending its database updates to the server. With the acknowledgement for this last message, the server sends back its database list, if any, in substantially the same prioritized list/acknowledgement (618) manner as above. The last such update message (620) indicates that server has reached end of the update list. This is followed by an acknowledgement from the client device to the VOD server (622), which terminates the synchronization session. Note that several possible variations of the sequence of communications are possible without affecting the scope of the invention. For example, one exemplary embodiment of this signal exchange could omit some or all of the acknowledgement signals.

### Web Pages for Out-of-Band Control

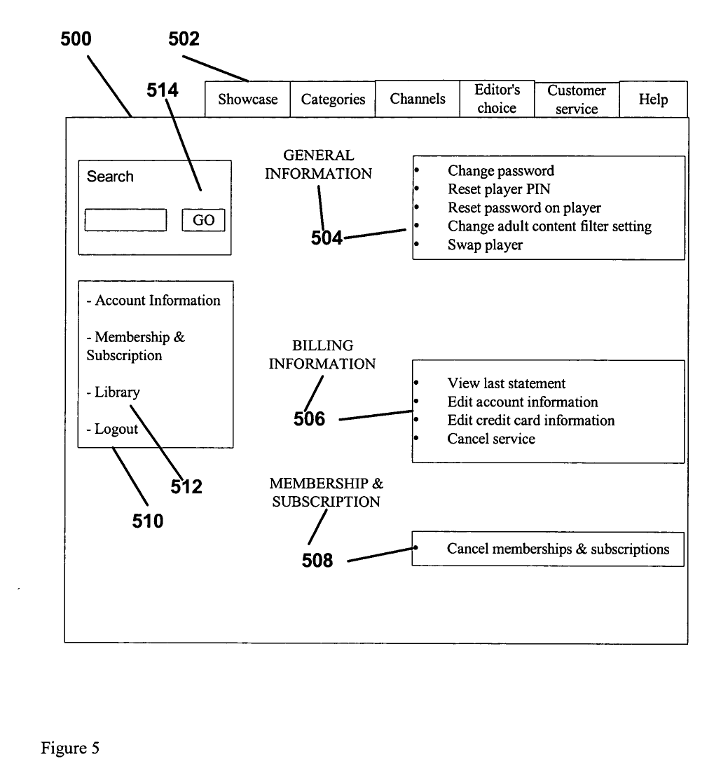

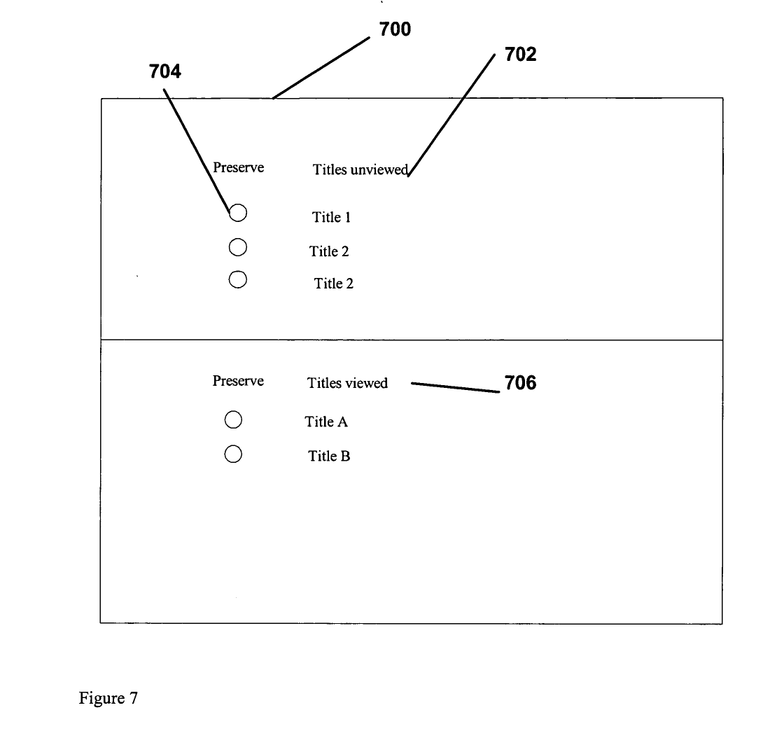

In an exemplary embodiment, out-of-band control of client devices is offered as a password authenticated secure interactive web session. The set of web pages personalized for a user and made available on the assignee's website (my.akimbo.com) is called the MyAkimbo™ service. The web pages are laid out to give the user substantially the same look-and-feel as the in-band sessions. No attempt is made to bring to the user's attention whether functions belong to category one, two or three. The client device control functions are also integrated with other useful features of a VOD service (such as recommendations: viewers' recommendations, service provider's recommendations, sponsor's recommendations, etc.), making the out-of-band interface a seamless combination of web browsing and in-band screen-by-screen control of the client device and VOD service. FIG. 5 shows an example layout of a MyAkimbo homepage offered to a user for out-of-band control of the VOD service and client device. The homepage 500 for a user includes a top level navigation bar 502 that allows easy navigation among functions, tools to search through available programs (514) and features of the VOD service organized in a logical fashion—group 504 includes general information, 506 included billing functions and group 508 relates to subscriptions and membership to various genre and packages of video programs. Account information tab on the side (510) allows access to Library (512) which shows a view of all titles stored on the client device's storage media as shown in FIG. 7.

### “My Library” Page

The library web page (700) is organized in terms of programs that are stored on the client device but have not been viewed by the user (702) and programs stored on the hard drive that have been viewed by the user (706). The user is allowed to preserve programs from automated deletion by indicating so on a check-box 704 next to each program title.

### General Information Page

General information page allows the user to perform functions that are conventionally performed over the in-band interface. These include for example, but not limited to, changing password for access to the account, resetting PIN password on the client device, changing parental control password and settings, changing password to purchase programs etc.

### Billing Information Page

Billing information page as shown in FIG. 5 contains functions that conventionally are available over the out-of-band interface. These include viewing account statements, changing payment options, viewing and changing account information and canceling the service.

### Membership and Subscription Page

This page is accessible by clicking on a tab at the top of the MyAkimbo homepage. This page contains account information that the user can control from this out-of-band control. The details of recently viewed programs that were billed to the account can be obtained as a sub-menu from this page. These details are refreshed every time synchronization is performed between the client device and the server.

Information related to available programming is presented in the form of a program guide, with look and functions substantially similar to that offered over the in-band interface. This includes presentation of metadata available for the programs, pricing, parental control ratings, maturity rating and so on.

In the foregoing specification, the invention has been described with reference to specific exemplary embodiments thereof. It will, however, be evident to those of ordinary skill in the art that various modifications and changes may be made thereto without departing from the broader spirit and scope of the invention as set forth in the appended claims. The specification and drawings are, accordingly, to be regarded in an illustrative rather than a restrictive sense and that it understood that the following claims including all equivalents are intended to define the scope of the invention.

What is claimed is:

1. A remote control for a set-top appliance, comprising a user interface accessible via the Internet, the user interface providing one or more views of a database configured so as to periodically synchronize with a content management application hosted at the set-top appliance, and a content availability guide configured to present multimedia content available for download by the set-top appliance.

2. The remote control of claim 1, wherein the user interface comprises a plurality of Web pages configured to resemble local user interface elements accessible at the set-top appliance via a television display and a wireless remote control unit.

3. The remote control of claim 1, wherein the database is configured to synchronize with the content management application in response to actions by the content management application.

4. The remote control of claim 3, wherein the actions by the content management application include requests for information regarding updates to the database made via the user interface.

5. The remote control of claim 1, wherein the user interface provides access to fewer than all available functions of the set-top appliance that are controllable via a local user interface accessible at the set-top appliance via a television display and a wireless remote control unit.

6. The remote control of claim 1, wherein the database is configured to synchronize with the content management application in response to updates to a locally stored version of the database at the set-top appliance.

7. The remote control of claim 6, wherein the locally stored version of the database is accessible via a local user interface accessible at the set-top appliance via a television display and a wireless remote control unit.

8. The remote control of claim 1, wherein changes made to the database via the user interface are replicated in a locally stored version of the database hosted at the set-top appliance during synchronization of the locally stored version of the database with the database.

9. The remote control of claim 8, wherein the synchronization of the locally stored version of the database with the database is performed in response to updates to the locally stored version of the database made via a local user interface accessible at the set-top appliance via a television display and a wireless remote control unit.

10. The remote control of claim 9, wherein the user interface comprises one or more Web pages organized to provide some, but not all, of the functionality of the local user interface.

11. The remote control of claim 10, wherein prior to deleting content from local storage of the set-top appliance, the database is updated to reflect such deletion.

12. The remote control of claim 10, wherein content scheduled for deletion from local storage of the set-top appliance can be preserved from deletion through user commands input via the user interface.

13. The remote control of claim 10, wherein through user commands entered via the user interface the set-top appliance can be instructed to download content to local storage thereof.

14. The remote control of claim 1 wherein conflicts between the database and a local version of the database hosted at the set-top appliance are resolved during the periodic synchronizations according to a priority scheme.

15. The remote control of claim 14, wherein the priority scheme is based on times at which conflicting instructions were entered.

16. A method, comprising controlling operations of a set-top appliance having a local computer-readable storage medium and a local user interface, which includes a wireless remote control, through an out-of-band communication channel that includes an Internet accessible user interface having one or more Web pages configured to provide views of a remote database maintained in substantial synchronization with a local database hosted at the set-top appliance and which contains information regarding content stored on the local computer-readable storage medium.

17. The method of claim 16, wherein the operations include content management operations involving downloading, preserving and deleting content to, on and from, respectively, the local computer-readable storage medium.

18. The method of claim 17, wherein the remote database is maintained in substantial synchronization with the local database through periodic communications therebetween, as initiated by the set-top appliance.

19. The method of claim 18, wherein at least some content management instructions entered via the Internet accessible user interface are permitted to preempt content management instructions entered via the local user interface.

20. The method of claim 16, wherein controlling operations of the set-top appliance comprises managing content stored on the local computer-readable medium in accordance with user instructions entered via the Internet accessible user interface.

21. The method of claim 20, wherein the user instructions are executed by a content management application hosted at the set-top appliance.

22. The method of claim 21, wherein the user instructions are not executed if contrary instructions were received by the set-top appliance via the local user interface.

23. The method of claim 21, wherein the user instructions are not executed if contrary instructions having a time stamp later than that of the user instructions were received by the set-top appliance via the local user interface.

24. A content management system for a set-top appliance, comprising an in-band user interface which includes a wireless remote control operable to display views of a local database hosted at the set-top appliance via a display device communicatively coupled thereto, and an out-of-band user interface including one or more Web pages configured to provide views of a remote database maintained in substantial synchronization with the local database hosted at a server remote from the set-top appliance.

25. The content management system of claim 24, wherein the server is accessible to the set-top appliance via the Internet.

26. The content management system of claim 24, wherein the remote database is synchronized with the local database in response to updates provided by the set-top appliance.

27. The content management system of claim 24, wherein both the in-band and out-of-band user interfaces are configured to accept user instructions for downloading, preserving and deleting multimedia content to, on, and from, respectively, a local computer-readable storage medium at the set-top appliance.

28. The content management system of claim 27, wherein the out-of-band user interface is further configured to provide a user with information concerning multimedia content available for download to the set-top appliance.

29. The content management system of claim 28, wherein the information concerning the multimedia content includes pricing information for downloading the multimedia content.

30. The content management system of claim 28, wherein the information concerning the multimedia content includes rating information for the multimedia content.

31. The content management system of claim 28, wherein the information concerning the multimedia content includes recommendations.

32. The content management system of claim 31, wherein the recommendations include advertiser-sponsored recommendations.

33. The content management system of claim 31, wherein the recommendations include service provider recommendations.

34. The content management system of claim 24, wherein the in-band and out-of-band user interfaces each provide the ability to control security settings of the set-top appliance.

35. The content management system of claim 34, wherein the security settings include passwords for authorizing payment for downloading content.

36. The content management system of claim 34, wherein the security settings include parental control settings.

37. The content management system of claim 34, wherein the parental control settings are responsive to maturity ratings for multimedia content downloaded to the set-top appliance.

38. The content management system of claim 34, wherein the security settings include passwords for authorizing downloading of content to the set-top appliance.

39. The content management system of claim 24, wherein some but not all of the functionality of the set-top appliance controllable via the in-band user interface is controllable via the out-of-band user interface.

40. The content management system of claim 24, wherein the out-of-band user interface provides for user interaction with at least one feature of a content delivery service accessible via the set-top appliance which is not accessible using the in-band user interface.
